(19) United States
(12) Patent Application Publication
(10) Pub. No.: US 2010/0283194 A1
(43) Pub. Date: Nov. 11, 2010

(54) ENERGY-SAVING VACUUM ADSORPTION APPARATUS

(76) Inventor: Zhen-Zhong HAN, Taiping City (TW)

Correspondence Address: Ching-Ling Huang, 5597 NW 127th Ter, Portland, OR, 97229, US

(21) Appl. No.: 12/463,423

(22) Filed: May 11, 2009

(51) Int. Cl. B25B 11/00

(52) U.S. Cl. 269/21

(57) ABSTRACT

An energy-saving vacuum adsorption apparatus to adsorb at least one article on a workstation includes an air compressor connecting to the workstation through a duct, a vacuum generator which is connected to the air compressor through the duct to suck air from the workstation into the duct and has a second control valve, a sealed vacuum tank to store the sucked air and provide pressure detection, a sensor connecting to the vacuum tank through a detection circuit to detect and control vacuum condition of the workstation, and a first control valve connecting to the detection circuit to control ON and OFF of the air compressor. The air compressor does not need operation for a long duration, thus can save electric power and has a longer life span.

### FIELD OF THE INVENTION

The present invention relates to an energy-saving vacuum adsorption apparatus to adsorb and anchor an article to facilitate processing thereof.

### BACKGROUND OF THE INVENTION

In processes of spray painting, cutting or other processing for an article, the article must be anchored on a workstation. For an article which is non-magnetic and non-clampable, a vacuum adsorption means is often being used to temporarily hold and anchor the article on the workstation. FIG. 1 illustrates a conventional vacuum adsorption apparatus that has a workstation 1 and an air compressor 2 connected through a duct. The air compressor 2 generates a vacuum adsorption condition. The workstation 1 has a plurality of adsorption apertures 3 to withdraw air through the air compressor 2 to adsorb an article (not shown in the drawing) mounted onto the workstation 1. The air compressor 2 provides driving source. When in use for adsorbing the article, a selected adsorption area is bordered through a rubber frame (not shown in the drawing), while the rest of the adsorption apertures 3 are plugged. Then the air compressor 2 is activated to generate vacuum to adsorb the article. The air compressor 2 has to operate continuously to maintain the vacuum adsorption effect so that the article can be firmly held while it is going through fabrication processes. Such continuous operation wastes electric power and results in a higher fabrication cost. The continuous operation of the air compressor 2 for a prolonged period of time also shortens its life span.

### SUMMARY OF THE INVENTION

Therefore, the primary object of the present invention is to provide an energy-saving vacuum adsorption apparatus that has a vacuum compressor and a vacuum generator to suck air from a workstation to generate a vacuum condition to adsorb an article on the workstation, thereby to reduce the cost of electric power and increase the life span of the air compressor.

To achieve the foregoing object, the energy-saving vacuum adsorption apparatus of the invention aims to adsorb at least one article on a workstation. The apparatus includes:

an air compressor connecting to the workstation through a duct;

a vacuum generator which is connected to the air compressor through the duct to suck air from the workstation into the duct, and has a second control valve which can be opened to release pressure;

a vacuum tank which is sealed to store the sucked air and provide pressure detection, and located on the duct between the workstation and the vacuum generator;

a sensor which is located on a detection circuit connecting to the vacuum tank to detect and control the vacuum condition of the workstation; and

a first control valve connecting to the detection circuit to control ON and OFF of the air compressor.

By means of the construction set forth above, the air compressor can be actuated to suck the air from the workstation to generate a vacuum condition to adsorb the article located thereon. The vacuum tank stores the sucked air and provides pressure detection. The sensor detects the pressure in the vacuum tank, and also detects the adsorption pressure of the workstation to reach a selected value. Then the detection circuit sends a signal to the first control valve to stop air compressor operation. When the adsorption pressure value of the workstation drops to a preset value, the first control valve controls resuming operation of the air compressor.

Through the aforesaid technical approach, the present invention provides many benefits, notably;

1. As the air compressor stops operation when the adsorption pressure of the workstation has reached a selected value, and resumes operation after the adsorption pressure value of the workstation has dropped to a preset value, the air compressor does not running continuously for a long duration. Thus electric power cost can be saved and the life span of the air compressor increases.

2. The air compressor drives the vacuum generator to suck the air from the workstation. The vacuum generator is less expensive equipment. Hence total facility cost can be reduced.

The foregoing, as well as additional objects, features and advantages of the invention will be more readily apparent from the following detailed description, which proceeds with reference to the accompanying embodiment and drawings. The embodiment serves only for illustrative purpose and is not the limitation of the invention.

### BRIEF DESCRIPTION OF THE DRAWINGS

FIG. 1 is a perspective view of a conventional vacuum adsorption apparatus.

FIG. 2 is a plane view of an embodiment of the invention.

FIG. 3 is a perspective view of an embodiment of the workstation of the invention.

### DETAILED DESCRIPTION OF THE PREFERRED EMBODIMENT

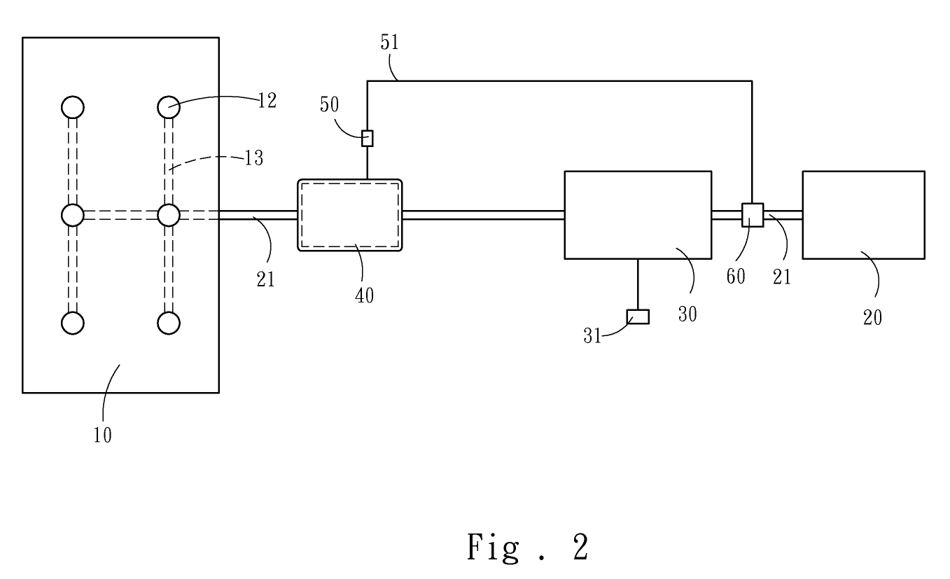

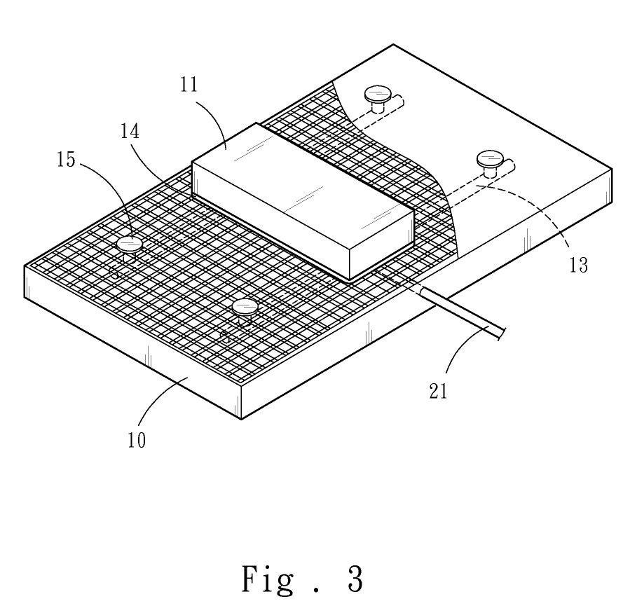

Please refer to FIGS. 2 and 3, the energy-saving vacuum adsorption apparatus of the invention aims to adsorb at least one article 11 on a workstation 10. The workstation 10 has at least one adsorption aperture 12 formed on the surface that is converged and communicated with at least one channel tube 13 located beneath the workstation 10. The vacuum adsorption apparatus of the invention includes an air compressor 20, a vacuum generator 30, a vacuum tank 40, a sensor 50 and a first control valve 60

The air compressor 20 is connected to the workstation 10 through a duct 21. The duct 21 communicates with the channel tube 13.

The vacuum generator 30 is connected to the air compressor 20 through the duct 21 to suck air from the workstation 10 into the duct 21, and has a second control valve 31 to release pressure.

The vacuum tank 40 is sealed to store the sucked air and provide pressure detection, and located on the duct 21 between the workstation 10 and the vacuum generator 30.

The sensor 50 is located on a detection circuit 51 connecting to the vacuum tank 40 to detect and control the vacuum pressure of the workstation 10.

The first control valve 60 is connected to the detection circuit 51 to control start of the air compressor 20 to suck the air, and stop operation of the air compressor 20 when the pressure value of the vacuum tank 40 reaches a selected range.

In practice, the workstation 10 has an adsorption area (not shown in the drawing) corresponding to the article 11 that is framed by a rubber frame 14 for holding the article 11. Other adoption apertures 12 outside the adsorption area are plugged respectively by an upper cap 15.

When in use to adsorb the article 11 on the workstation 10, through the first control valve 60 the air compressor 20 is started, and the vacuum generator 30 sucks the air in the duct 21 to withdraw the air within the rubber frame 14 through the aperture 12. The withdrawn air enters the duct 21 through channel tubes 13 into the vacuum tank 40. The workstation 10 maintains a negative pressure to adsorb the article 11. The vacuum tank 40 stores the withdrawn air and provides pressure detection to avoid the insensitive measurement of the sensor 50 occurred to the conventional technique that has the channel tubes 13 located below the adsorption aperture 12 to form a partial pressure of the vacuum pressure for detection.

When to remove the article 11 from the workstation 10 is desired, open the second control valve 31 to let external air to enter the duct 21 and the channel tube 13, and flow to the adsorption aperture 12 of the workstation 10. The adsorption pressure of the article 11 can be released. And the first control valve 60 sets the air compressor 20 OFF in a pressure release condition.

The sensor 50 is located on the detection circuit 51 bridging the vacuum tank 40 and the air compressor 20. When the sensor 50 detects the internal pressure value of the vacuum tank 40 reaching a selected value, the air compressor 20 stops operation. On the other hand, when the adsorption pressure value in the vacuum tank 40 drops to a preset value, the first control valve 60 activates the air compressor 20 to resume operation.

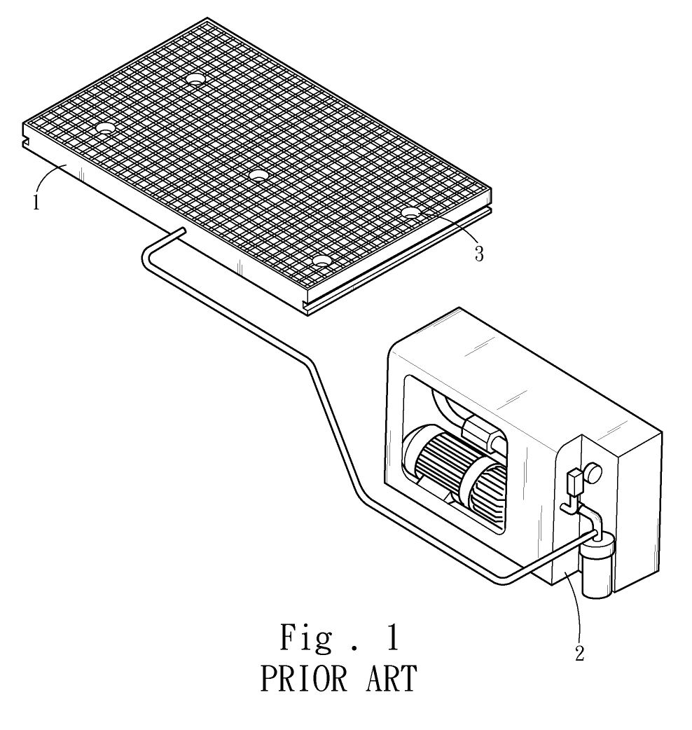

Thus the air compressor 20 stops operation when the workstation 10 adsorbs the article 11 at the selected pressure value, and resumes operation when the adsorption pressure value drops to the preset value. Compared with the conventional vacuum adsorption apparatus shown in FIG. 1, the present invention can save a lot of electric power cost. Moreover, the air compressor 20 does not need to be continuous running for a long duration, hence wearing can be reduced and its life span is longer.

In addition, in the invention the air compressor 20 provides driving power to drive the vacuum generator 30 to withdraw the air from the duct 21. The vacuum generator 30 is less expensive equipment, hence total facility cost also can be reduced.

What is claimed is:

1. An energy-saving vacuum adsorption apparatus to adsorb at least one article on a workstation, comprising:
an air compressor connected to the workstation through a duct;
a vacuum generator which is connected to the air compressor through the duct to suck air from the workstation into the duct and has a second control valve to release pressure;
a vacuum tank which is sealed to store the sucked air and provide pressure detection and located on the duct between the workstation and the vacuum generator;
a sensor which is located on a detection circuit connecting to the vacuum tank to detect and control vacuum condition of the vacuum tank; and
a first control valve connecting to the detection circuit to control ON and OFF of the air compressor.

2. The energy-saving vacuum adsorption apparatus of claim 1, wherein the workstation has at least one adsorption aperture communicating with each other and converging through at least one channel tube.

3. The energy-saving vacuum adsorption apparatus of claim 2, wherein the channel tube is connected to the duct.

4. The energy-saving vacuum adsorption apparatus of claim 2, wherein the workstation has an adsorption area corresponding with the article and coupled with a rubber frame to mate the adsorption aperture to serve as a function area.

5. The energy-saving vacuum adsorption apparatus of claim 4, wherein each adsorption aperture outside the adsorption area has a mating upper cap.
